(19) United States
(12) Patent Application Publication
(10) Pub. No.: US 2024/0094552 A1
(43) Pub. Date: Mar. 21, 2024

(54) GEOMETRICAL WAVEGUIDE WITH PARTIAL-COVERAGE BEAM SPLITTERS

(71) Applicant: Meta Platforms Technologies, LLC, Menlo Park, CA (US)

(72) Inventors: Miaomiao Xu, Redmond, WA (US); Wanli Chi, Sammamish, WA (US); Alexander Sohn, Seattle, WA (US)

(21) Appl. No.: 18/171,944

(22) Filed: Feb. 21, 2023

Related U.S. Application Data
(60) Provisional application No. 63/343,193, filed on May 18, 2022.

(51) Int. Cl. G02B 27/10; G02B 6/28; G02B 27/01

(52) U.S. Cl. CPC G02B 27/106; G02B 6/2817; G02B 27/0172

(57) ABSTRACT

A waveguide may include a substrate and an array of beam splitters embedded within the substrate, where each beam splitter within the array of beam splitters does not fully transect the substrate. Various other devices, systems, and methods of manufacture are also disclosed.

### CROSS REFERENCE TO RELATED APPLICATION

This application claims the benefit of U.S. Provisional Application No. 63/343,193, filed 18 May 2022, the disclosure of which is incorporated, in its entirety, by this reference.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 is a diagram of an example geometrical waveguide with full-coverage beam splitters.

FIG. 2 is a diagram of an example geometrical waveguide with partial-coverage beam splitters.

FIG. 3 is a diagram of the geometrical waveguide of FIG. 2 showing an example path of light.

FIG. 4 is a diagram of an example method for manufacturing a geometrical waveguide with partial-coverage beam splitters.

FIG. 5 is an illustration of an example lens incorporating waveguides.

FIG. 6 is an illustration of an example lens incorporating an integral waveguide device.

FIG. 7 is an illustration of exemplary augmented-reality glasses that may be used in connection with embodiments of this disclosure.

FIG. 8 is an illustration of an exemplary virtual-reality headset that may be used in connection with embodiments of this disclosure.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

Geometrical waveguides may have beam splitters that transect the full thickness of the waveguide substrate. However, beam splitters that fully transect the substrate may limit design possibilities, as traveling beyond any given beam splitter may require a beam of light to pass through the beam splitter (and be subjected to the reflectivity of the beam splitter). In addition, manufacturing waveguides can be procedurally complex and expensive.

The present disclosure describes geometrical waveguides with beam splitters that do not transect the full thickness of the substrate, and methods for manufacturing the same. A geometrical waveguide with shorter beam splitters may allow for designs in which some rays of light may pass around the beam splitters, enabling, e.g., improvements to efficiency and to the uniformity of light entering the eye box. Furthermore, a manufacturing approach may be simpler and more flexible by placing custom grooves (of any depth and orientation) in an integral polymer before applying a reflective coating to the grooves. In addition, the resulting waveguide may be lightweight by using polymer material instead of, e.g., glass.

Features from any of the embodiments described herein may be used in combination with one another in accordance with the general principles described herein. These and other embodiments, features, and advantages will be more fully understood upon reading the following detailed description in conjunction with the accompanying drawings and claims.

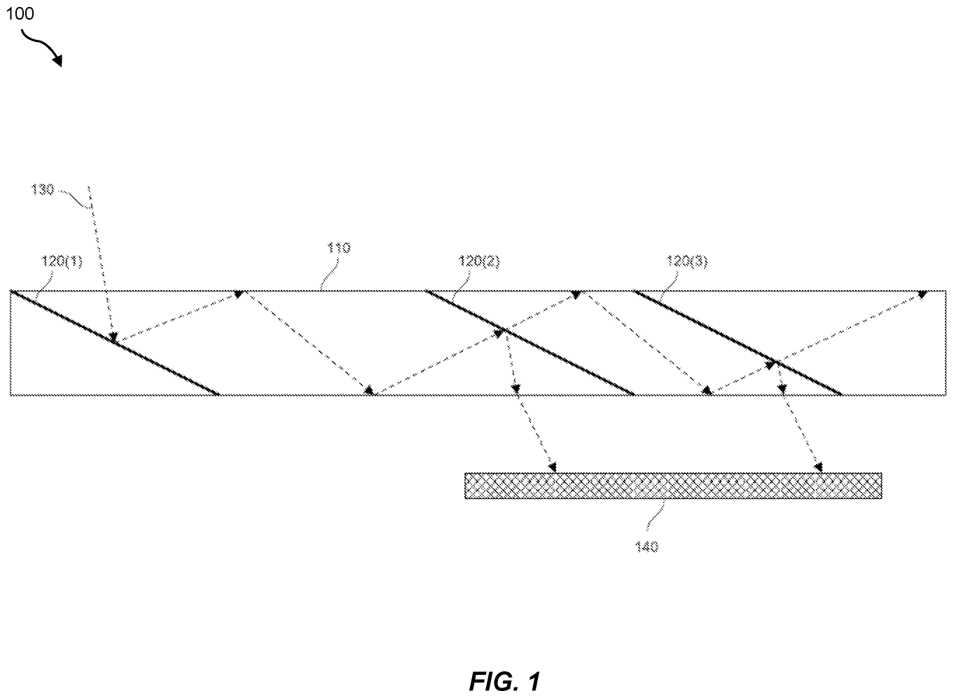

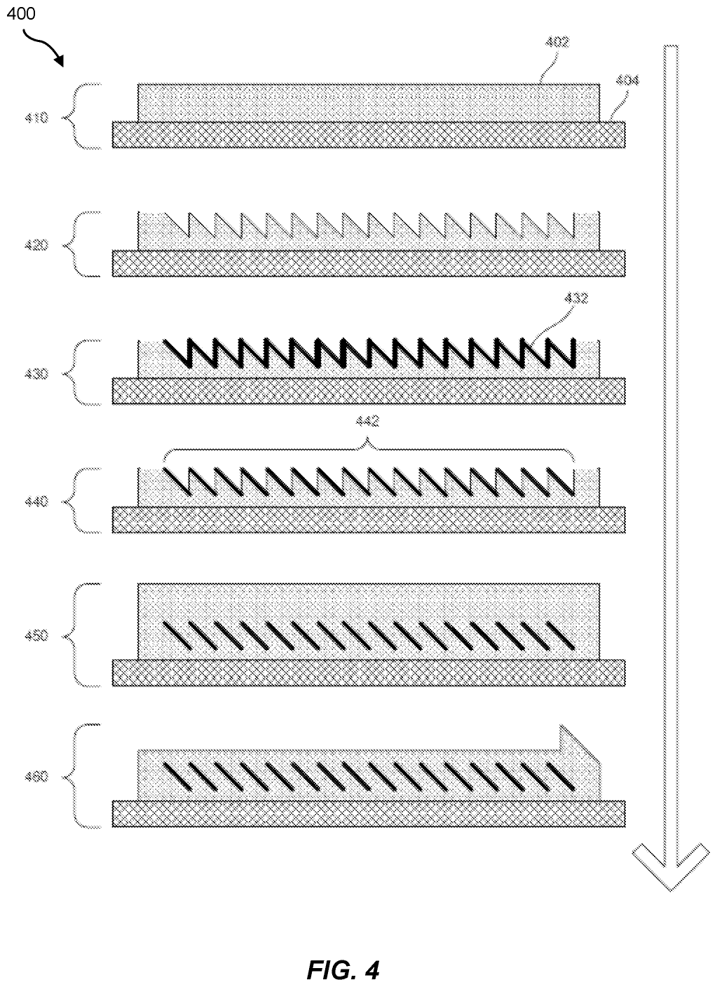

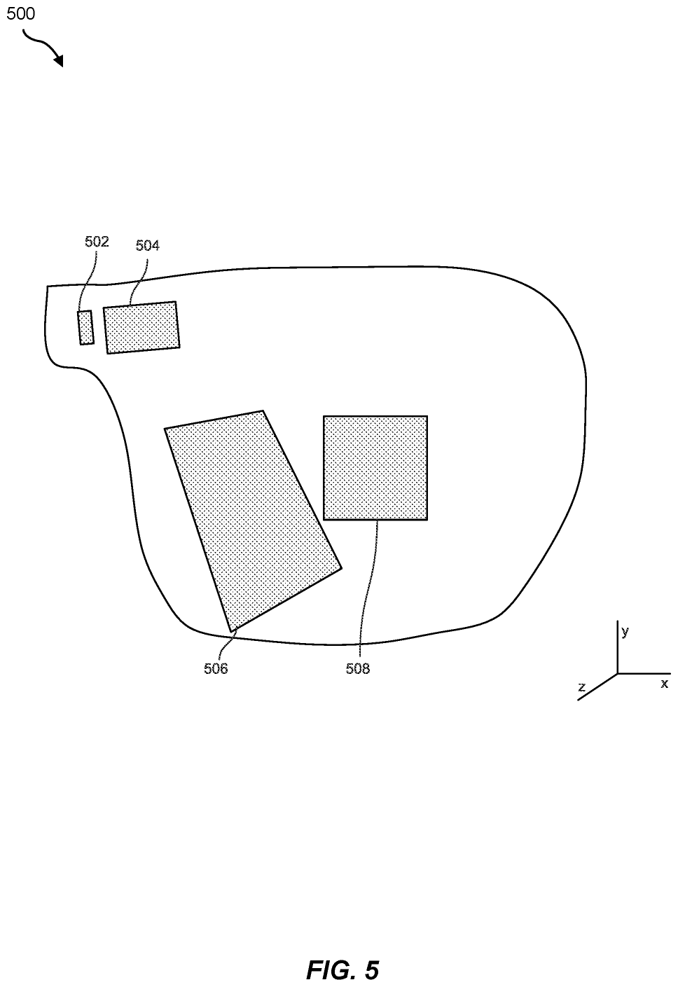

The following will provide, with reference to FIGS. 1-3, detailed descriptions of waveguides; with reference to FIG. 4, detailed descriptions of methods of manufacture for waveguides with partial-coverage beams splitters; and with reference to FIGS. 5-8, detailed descriptions of devices and systems that may incorporate one or more waveguides described herein.

FIG. 1 is a diagram of an example geometrical waveguide with full-coverage beam splitters. As shown in FIG. 1, a geometrical waveguide 100 may include a substrate 110 and beam splitters 120(1)-(3). Beam splitters 120(1)-(3) may partly transmit and partly reflect a beam of light 130. Waveguide 100 may thereby direct some of beam of light 130 to an eye box 140.

Substrate 110 (and other waveguide substrates described herein) may include any suitable material. In some examples, substrate 110 may include a transparent polymer. By way of example, without limitation, substrate 110 may include polycarbonate, polystyrene, and/or polymethyl methacrylate. In other examples, substrate 110 may include glass or silica. In general, substrate 110 may include any material that is transparent to wavelengths for which waveguide 100 is used.

Beam splitters 120(1)-(3) (and other beam splitters discussed herein) may be of any suitable type of beam splitter. Examples of beam splitters include, e.g., mirrored beam splitters, non-polarizing beam splitters, and polarizing beam splitters. As mentioned earlier, a beam splitter may either transmit or reflect a ray of light. Thus, in some examples, one or more beam splitters described herein may either transmit a ray of light, allowing the ray of light to propagate further along the waveguide, or reflect the ray of light, directing the ray of light toward an output of the device (e.g., an output coupler). Light that exits the waveguide may variously reach an eye box or another system or device (e.g., another waveguide). Beam splitters may demonstrate any of a variety of reflection/transmission ratios. For example, some beam splitters may reflect approximately half of all rays and transmit approximately half of all rays. Some beam splitters may reflect rays in greater proportion, while some beam splitters may transmit rays in greater proportion. As will be described in greater detail below, in some examples one or more of the waveguides described herein may include beam splitters with differing reflection/transmission ratios.

As can be seen in FIG. 1, beam splitters 120(1)-(3) may run completely through substrate 110, such that, as beam of light 130 progresses through waveguide 100, beam of light 130 is partly reflected by each of beam splitters 120(1)-(3).

Although not depicted in FIG. 1, waveguide 100 may include an input coupler (e.g., attached to waveguide 100 where beam of light 130 enters waveguide 100). Additionally or alternatively, waveguide 100 may include an output coupler (e.g., attached to waveguide 100 at the areas where portions of beam of light 130 exit waveguide 100). Other waveguides depicted and described herein may likewise include input couplers and/or output couplers.

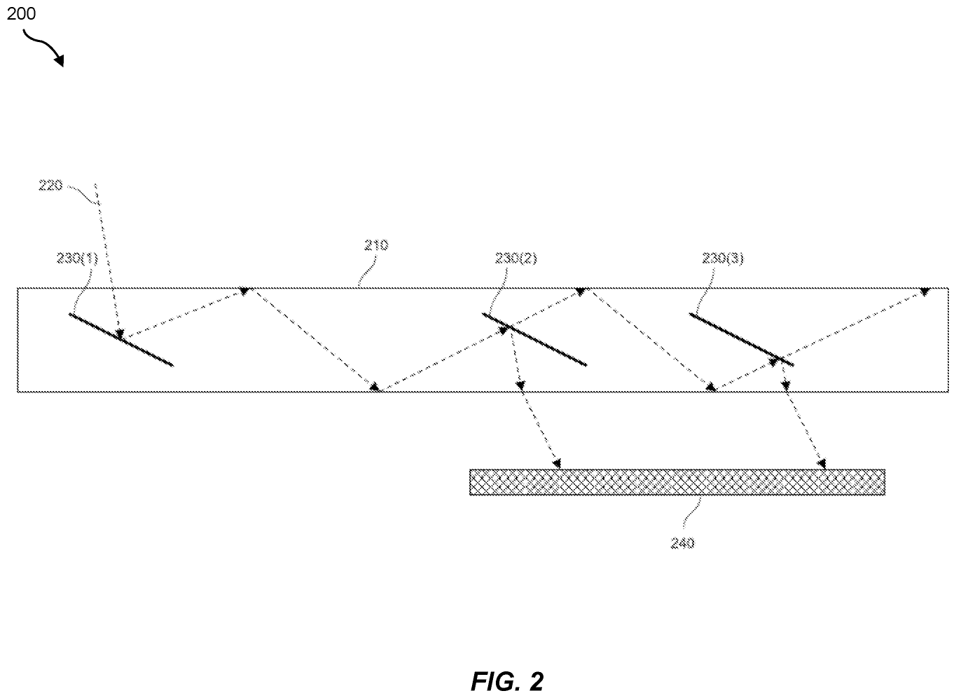

FIG. 2 is a diagram of an example geometrical waveguide with partial-coverage beam splitters. As shown in FIG. 2, a geometrical waveguide 200 may include a substrate 210 and beam splitters 220(1)-(3). Beam splitters 220(1)-(3) may partly transmit and partly reflect a beam of light 130. Waveguide 200 may thereby direct some of beam of light 230 to an eye box 240.

As can be seen in FIG. 2, beam splitters 120(1)-(3) may not run completely through substrate 110. Rather, beam splitters 120(1)-(3) may be embedded within substrate 110 while leaving margins of substrate around (e.g., above and/or below) beam splitters 120(1)-(3). Nevertheless, as may be appreciated, in one example beam of light 220 may propagate through the same paths as beam of light 120. Thus, if beam of light 120 is equivalent to beam of light 220, the same image may reach eye box 140 from beam of light 120 as reaches eye box 240 from beam of light 220.

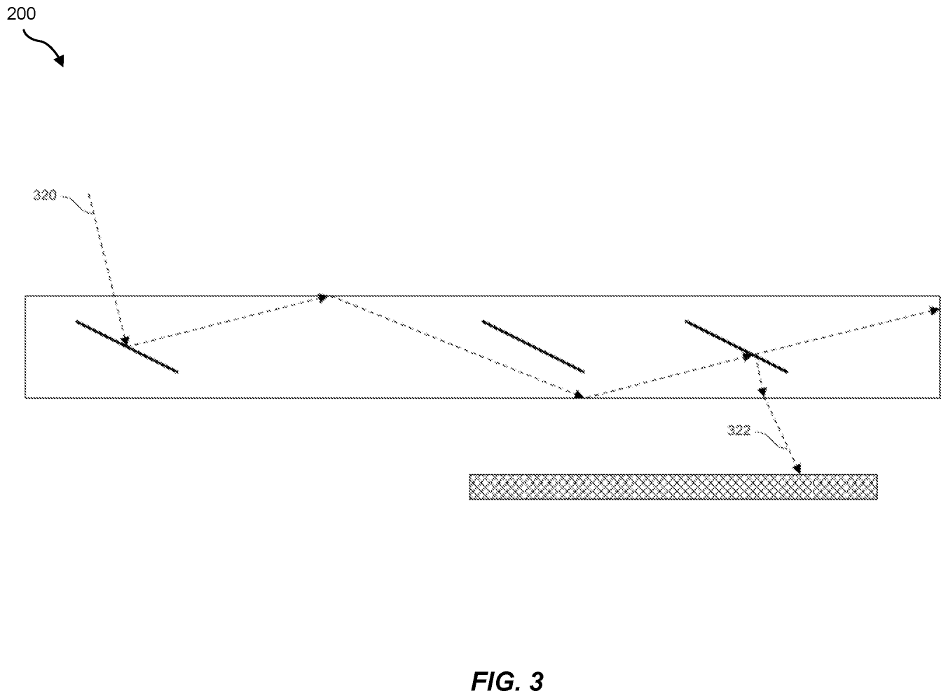

FIG. 3 is a diagram of the geometrical waveguide of FIG. 2 showing an example path of light. As shown in FIG. 3, a beam of light 320 may take a different path through waveguide 200. Notably, beam of light 320 may pass below beam splitter 220(2). Thus, beam of light 320 may not be split until reaching beam splitter 220(3), thereby reaching beam splitter 220(3) with full intensity. Thus, a beam of light 322 that reflected from beam splitter 220(3) and reaches eye box 240 may have a greater intensity that it would have had it first passed through beam splitter 220(2).

Accordingly, while the shortened beam splitters 220(1)-(3) of waveguide 200 may allow for a similar design and use for waveguide 200 as with waveguide 100, as shown with respect to FIGS. 1-2, the shortened beam splitters 220(1)-(3) of waveguide 200 may also allow for different designs and uses for waveguide 200 as distinguished from waveguide 100 (e.g., by potentially increasing efficiency and uniformity of light to the eye box), as shown with respect to FIGS. 2-3.

Thus, for example, the design of waveguide 200 may allow for various ray paths from the waveguide input to the waveguide output. Some ray paths may intersect with beam splitters 220(1)-(3), but some ray paths may, e.g., pass around a beam splitter before intersecting with a subsequent beam splitter (e.g., pass around beam splitter 220(2) before intersecting with beam splitter 220(3)).

As mentioned earlier, beam splitters may transmit and reflect rays in varying proportions. Thus, beam splitters that are more reflective may be less transmissive (and vice versa). In some examples, in one or more of the waveguides described herein, more reflective beam splitters may be used closer to the output of the waveguide (and less reflective beam splitters closer to the input).

Furthermore, as will be described in greater detail below, in some examples the beam splitters in one or more of the waveguides described herein may increase in size (e.g., be longer) closer to the output of the waveguide (and decrease in size closer to the input).

In some examples, using less reflective beam splitters closer to the input of the waveguide and more reflective beam splitters closer to the output of the waveguide may help to achieve uniformity of output (e.g., of signal intensity) across various exit points of the waveguide. Additionally or alternatively, using smaller (e.g., shorter) beam splitters closer to the input of the waveguide may help to achieve uniformity of output across various exit points of the waveguide. In some examples, the average amount of light reflected out of the waveguide may by each beam splitter may be substantially uniform. For example, the degree of reflectivity of the beam splitters and the size of the beam splitters may be selected to result in substantially uniformity of signal intensity across the exit points of the waveguide.

In some examples, as will be discussed in greater detail below, one or more beam splitters in a waveguide may be angled differently and/or have different orientations with respect to each other.

FIG. 4 is a diagram of an example method 400 for manufacturing a geometrical waveguide with partial-coverage beam splitters. As shown in FIG. 4, at step 410, a polymer 402 may be situated on a substrate 404. At step 420, grooves may be cut into polymer 402 (e.g., via diamond turning). At step 430, a partially reflective coating 432 may be applied to the surface of the grooves cut into polymer 402. At step 440, the reflective coating 432 may be removed from the vertical surfaces of the grooves (e.g., via diamond turning). Reflective coating 432 may thereby be transformed into an array of beam splitters 442. At step 450, a liquid layer of the polymer may be applied, fully encapsulating beam splitters 442 within polymer 402. At step 460, polymer 402 may be cut into its final shape (e.g., via diamond turning). Polymer 402 may then be detached from substrate 404.

In some examples, partially reflecting coating 432 may be applied with a gradient, such that the reflectivity partially reflective coating 432 is lower at one end of the coating and higher at the other end of the coating. Thus array of beam splitters 442 may be an array of progressively more reflective beam splitters. This may increase the efficiency of the waveguide (by reducing the amount of light reflected out early in the array) as well as increase the uniformity of the waveguide (by, e.g., making approximately the same amount of light leave the waveguide at each beam splitter).

While FIG. 4 shows grooves cut at a uniform depth, at uniform angles, with uniform spacing, and with uniform orientations, it may be appreciated that grooves may be cut at varying depths, angles, spacings, and/or orientations. In one example, grooves to one end of the waveguide (e.g., the end where the light enters) may be shallower and/or smaller, while the grooves to the other end of the waveguide may be progressively deeper and/or larger, such that the beam splitters formed on the grooves may be smaller to one end and larger to the other. This may increase the efficiency of the waveguide (by reducing the amount of light reflected out early in the array) as well as increase the uniformity of the waveguide (by, e.g., making approximately the same amount of light leave the waveguide at each beam splitter). Likewise, the grooves may be formed at varying angles and/or varying orientations. Because each groove may be separately formed, it may be feasible from a manufacturing approach to create a custom depth, angle, spacing, and orientation for each groove.

Additionally or alternatively, as will be described in greater detail below, multiple distinct arrays of beam splitters may be cut using an integral piece of polymer. Thus, for example, multiple custom functional waveguides may be manufactured in a single piece of polymer. In some examples, one such waveguide may transmit light to a subsequent waveguide.

FIG. 5 illustrates an example lens 500. As shown in FIG. 5, lens 500 may include a waveguide 502, a waveguide 504, a waveguide 506, and a waveguide 508. Waveguide 502 may receive input light from any suitable source, including, e.g., a display signal (e.g., an augmented reality display signal). The output of waveguide 502 may provide input to waveguide 504. The output of waveguide 504 may provide input to waveguide 506. The output of waveguide 506 may provide input to waveguide 508. The output of waveguide 508 may project onto an eye box, such that a user wearing lens 500 sees a display image. Because each waveguide is receiving input light and projecting output light in different directions, each waveguide may use custom beam splitter spacings, sizes, degrees of reflectivity, angles, orientations, etc. As may be appreciated, the devices and methods described herein may enable this diversity of waveguide designs.

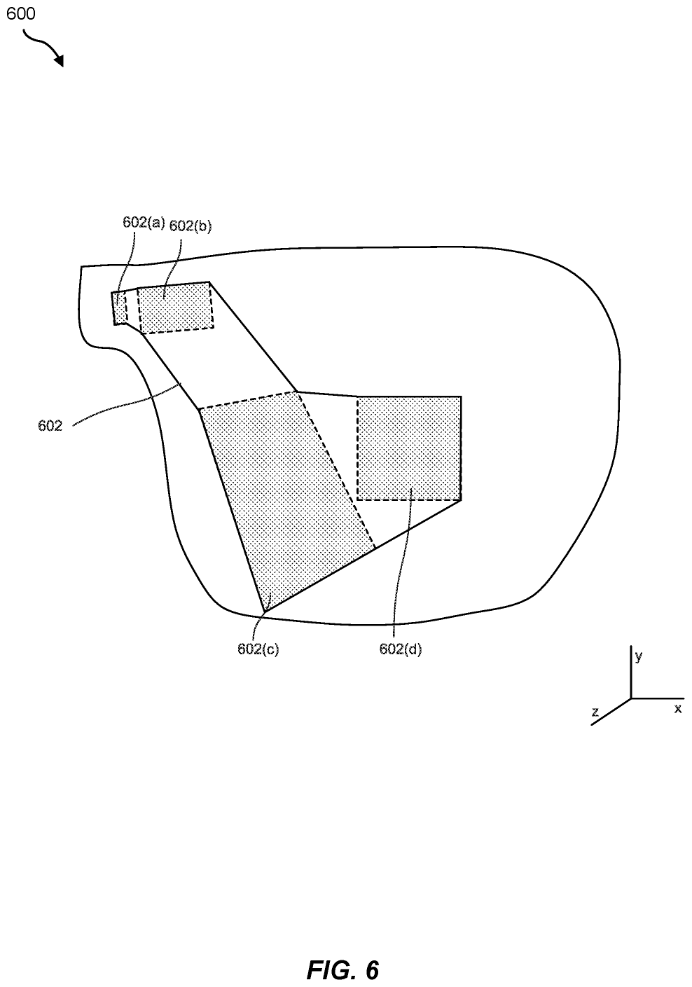

FIG. 6 illustrates an example lens 600. As shown in FIG. 6, lens 600 may include an integrated waveguide device 602. Integrated waveguide device 602 may include functional waveguides 602(a)-(d). Waveguide 602(a) may receive input light from any suitable source, including, e.g., a display signal (e.g., an augmented reality display signal). The output of waveguide 602(a) may provide input to waveguide 602(b). The output of waveguide 602(b) may provide input to waveguide 602(c). The output of waveguide 602(c) may provide input to waveguide 602(d). The output of waveguide 602(d) may project onto an eye box, such that a user wearing lens 600 sees a display image.

In some examples, integrated waveguide device 602 may be formed from a single integral piece of material. Thus, for example, instead of separately manufacturing waveguides 502, 504, 506, and 508, and precisely arranging them across lens 500, as in FIG. 5, a method of manufacture may include forming partial-coverage beam splitters of varying spacings, sizes, angles, orientations, and degrees of reflectivity in a single, integral piece of material, resulting in integrated waveguide device 602, and coupling integrated waveguide device 602 to lens 600. In some examples, this may make the manufacturing process simpler, quicker, and/or more cost effective. In addition, in some examples, by not needing to separately arrange the waveguides on the lens, this approach may eliminate a step that would otherwise take more time, equipment, and/or introduce additional possibilities for error (e.g., misalignments between waveguides).

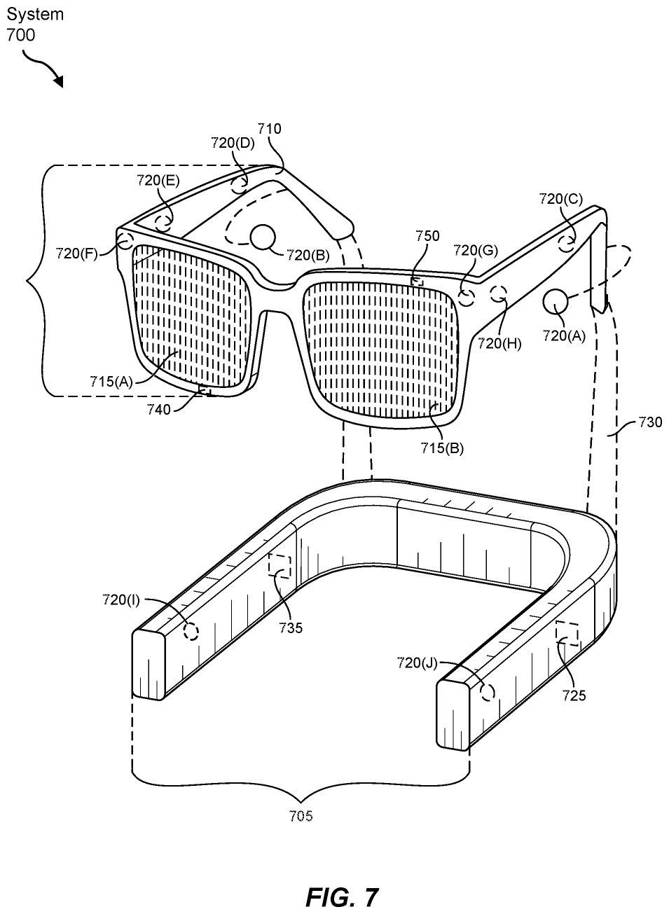

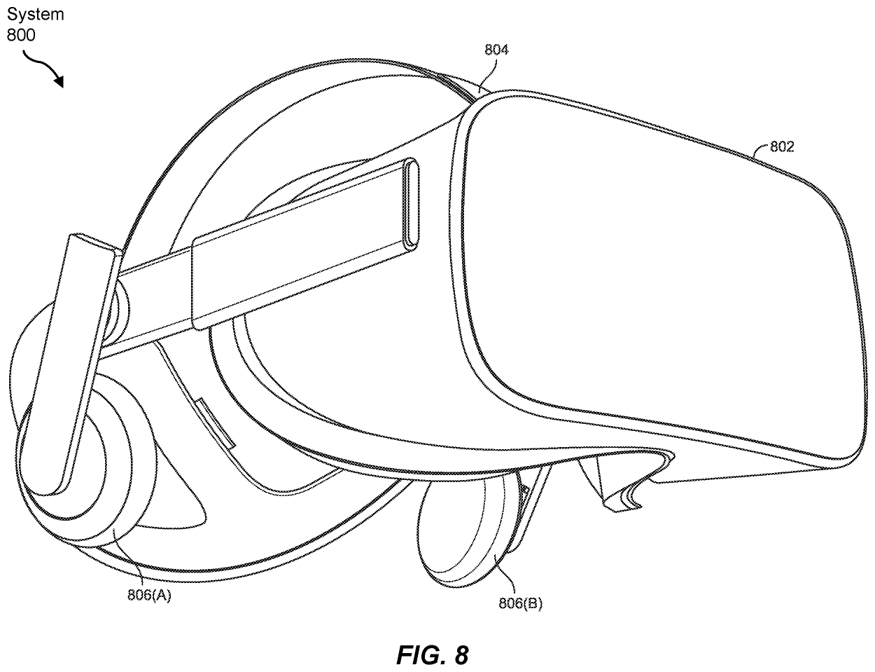

As may be appreciated from FIGS. 5-6, one or more of the waveguides described herein may be incorporated into a head-mounted display, such as one or more of the systems described below with respect to FIGS. 7-8.

### EXAMPLE EMBODIMENTS

Example 1: A device may include a substrate and an array of beam splitters embedded within the substrate, where each beam splitters within the array of beam splitters does not fully transect the substrate.

Example 2: The device of Example 1, where each beam splitter within the array of beam splitters is configured to transmit a first proportion of rays and to reflect a second proportion of rays.

Example 3: The device of any of Examples 1 and 2, where the device is configured to provide multiple ray paths from an input of the device to an output of the device, and at least one of the ray paths bypasses at least one beam splitter and intersects with at least one subsequent beam splitter.

Example 4: The device of any of Examples 1-3, where each beam splitter within the array of beam splitters is progressively more reflective in a direction of an output of the device.

Example 5: The device of any of Examples 1-4, where an average amount of light reflected out of the device by each beam splitter within the array of beam splitters is substantially uniform.

Example 6: The device of any of Examples 1-5, where the average amount of light reflected out of the device by each beam splitter within the array of beam splitters is substantially uniform based on: a proportion of ray paths that bypass each beam splitter within the array of beam splitters and a degree of reflectivity of each beam splitter within the array of beam splitters.

Example 7: The device of any of Examples 1-6, where each beam splitter within the array of beam splitters is progressively longer in a direction of an output of the device.

Example 8: The device of any of Examples 1-7, where a first beam splitter within the array of beam splitters is set at a different angle within the device than a second beam splitter within the array of beam splitters.

Example 9: A method of manufacture may include removing material from a substrate such that the substrate defines a series of sloping grooves; applying a partially reflective coating over a slope of each of the sloping grooves; and overcasting the substrate with additional material such that the series of sloping grooves are filled in and the partially reflective coating is fully surrounded by substrate.

Example 10: The method of Example 9, where the substrate includes a polymer material.

Example 11: The method of any of Examples 9-10, where applying the partially reflective coating includes applying a gradient of progressively more reflecting coating such that partially reflective coating of each groove in the series of sloping grooves is progressively more reflective.

Example 12: The method of any of Examples 9-11, further including, after applying the partially reflective coating and before overcasting the substrate, removing the partially reflective coating from one or more portions of a surface of the substrate.

Example 13: The method of any of Examples 9-12, where removing the material from the substrate such that the substrate defines the series of sloping grooves includes removing material to different depths at different positions of the substrate such that a maximum depth of at least one sloping groove within the series of sloping grooves differs from a maximum depth of at least one other sloping groove within the series of sloping grooves.

Embodiments of the present disclosure may include or be implemented in conjunction with various types of artificial-reality systems. Artificial reality is a form of reality that has been adjusted in some manner before presentation to a user, which may include, for example, a virtual reality, an augmented reality, a mixed reality, a hybrid reality, or some combination and/or derivative thereof. Artificial-reality content may include completely computer-generated content or computer-generated content combined with captured (e.g., real-world) content. The artificial-reality content may include video, audio, haptic feedback, or some combination thereof, any of which may be presented in a single channel or in multiple channels (such as stereo video that produces a three-dimensional (3D) effect to the viewer). Additionally, in some embodiments, artificial reality may also be associated with applications, products, accessories, services, or some combination thereof, that are used to, for example, create content in an artificial reality and/or are otherwise used in (e.g., to perform activities in) an artificial reality.

Artificial-reality systems may be implemented in a variety of different form factors and configurations. Some artificial-reality systems may be designed to work without near-eye displays (NEDs). Other artificial-reality systems may include an NED that also provides visibility into the real world (such as, e.g., augmented-reality system 700 in FIG. 7) or that visually immerses a user in an artificial reality (such as, e.g., virtual-reality system 800 in FIG. 8). While some artificial-reality devices may be self-contained systems, other artificial-reality devices may communicate and/or coordinate with external devices to provide an artificial-reality experience to a user. Examples of such external devices include handheld controllers, mobile devices, desktop computers, devices worn by a user, devices worn by one or more other users, and/or any other suitable external system.

Turning to FIG. 7, augmented-reality system 700 may include an eyewear device 702 with a frame 710 configured to hold a left display device 715(A) and a right display device 715(B) in front of a user's eyes. Display devices 715(A) and 715(B) may act together or independently to present an image or series of images to a user. While augmented-reality system 700 includes two displays, embodiments of this disclosure may be implemented in augmented-reality systems with a single NED or more than two NEDs.

In some embodiments, augmented-reality system 700 may include one or more sensors, such as sensor 740. Sensor 740 may generate measurement signals in response to motion of augmented-reality system 700 and may be located on substantially any portion of frame 710. Sensor 740 may represent one or more of a variety of different sensing mechanisms, such as a position sensor, an inertial measurement unit (IMU), a depth camera assembly, a structured light emitter and/or detector, or any combination thereof. In some embodiments, augmented-reality system 700 may or may not include sensor 740 or may include more than one sensor. In embodiments in which sensor 740 includes an IMU, the IMU may generate calibration data based on measurement signals from sensor 740. Examples of sensor 740 may include, without limitation, accelerometers, gyroscopes, magnetometers, other suitable types of sensors that detect motion, sensors used for error correction of the IMU, or some combination thereof.

In some examples, augmented-reality system 700 may also include a microphone array with a plurality of acoustic transducers 720(A)-720(J), referred to collectively as acoustic transducers 720. Acoustic transducers 720 may represent transducers that detect air pressure variations induced by sound waves. Each acoustic transducer 720 may be configured to detect sound and convert the detected sound into an electronic format (e.g., an analog or digital format). The microphone array in FIG. 7 may include, for example, ten acoustic transducers: 720(A) and 720(B), which may be designed to be placed inside a corresponding ear of the user, acoustic transducers 720(C), 720(D), 720(E), 720(F), 720(G), and 720(H), which may be positioned at various locations on frame 710, and/or acoustic transducers 720(1) and 720(J), which may be positioned on a corresponding neckband 705.

In some embodiments, one or more of acoustic transducers 720(A)-(J) may be used as output transducers (e.g., speakers). For example, acoustic transducers 720(A) and/or 720(B) may be earbuds or any other suitable type of headphone or speaker.

The configuration of acoustic transducers 720 of the microphone array may vary. While augmented-reality system 700 is shown in FIG. 7 as having ten acoustic transducers 720, the number of acoustic transducers 720 may be greater or less than ten. In some embodiments, using higher numbers of acoustic transducers 720 may increase the amount of audio information collected and/or the sensitivity and accuracy of the audio information. In contrast, using a lower number of acoustic transducers 720 may decrease the computing power required by an associated controller 750 to process the collected audio information. In addition, the position of each acoustic transducer 720 of the microphone array may vary. For example, the position of an acoustic transducer 720 may include a defined position on the user, a defined coordinate on frame 710, an orientation associated with each acoustic transducer 720, or some combination thereof.

Acoustic transducers 720(A) and 720(B) may be positioned on different parts of the user's ear, such as behind the pinna, behind the tragus, and/or within the auricle or fossa. Or, there may be additional acoustic transducers 720 on or surrounding the ear in addition to acoustic transducers 720 inside the ear canal. Having an acoustic transducer 720 positioned next to an ear canal of a user may enable the microphone array to collect information on how sounds arrive at the ear canal. By positioning at least two of acoustic transducers 720 on either side of a user's head (e.g., as binaural microphones), augmented-reality device 700 may simulate binaural hearing and capture a 3D stereo sound field around about a user's head. In some embodiments, acoustic transducers 720(A) and 720(B) may be connected to augmented-reality system 700 via a wired connection 730, and in other embodiments acoustic transducers 720(A) and 720(B) may be connected to augmented-reality system 700 via a wireless connection (e.g., a BLUETOOTH connection). In still other embodiments, acoustic transducers 720(A) and 720(B) may not be used at all in conjunction with augmented-reality system 700.

Acoustic transducers 720 on frame 710 may be positioned in a variety of different ways, including along the length of the temples, across the bridge, above or below display devices 715(A) and 715(B), or some combination thereof. Acoustic transducers 720 may also be oriented such that the microphone array is able to detect sounds in a wide range of directions surrounding the user wearing the augmented-reality system 700. In some embodiments, an optimization process may be performed during manufacturing of augmented-reality system 700 to determine relative positioning of each acoustic transducer 720 in the microphone array.

In some examples, augmented-reality system 700 may include or be connected to an external device (e.g., a paired device), such as neckband 705. Neckband 705 generally represents any type or form of paired device. Thus, the following discussion of neckband 705 may also apply to various other paired devices, such as charging cases, smart watches, smart phones, wrist bands, other wearable devices, hand-held controllers, tablet computers, laptop computers, other external compute devices, etc.

As shown, neckband 705 may be coupled to eyewear device 702 via one or more connectors. The connectors may be wired or wireless and may include electrical and/or non-electrical (e.g., structural) components. In some cases, eyewear device 702 and neckband 705 may operate independently without any wired or wireless connection between them. While FIG. 7 illustrates the components of eyewear device 702 and neckband 705 in example locations on eyewear device 702 and neckband 705, the components may be located elsewhere and/or distributed differently on eyewear device 702 and/or neckband 705. In some embodiments, the components of eyewear device 702 and neckband 705 may be located on one or more additional peripheral devices paired with eyewear device 702, neckband 705, or some combination thereof.

Pairing external devices, such as neckband 705, with augmented-reality eyewear devices may enable the eyewear devices to achieve the form factor of a pair of glasses while still providing sufficient battery and computation power for expanded capabilities. Some or all of the battery power, computational resources, and/or additional features of augmented-reality system 700 may be provided by a paired device or shared between a paired device and an eyewear device, thus reducing the weight, heat profile, and form factor of the eyewear device overall while still retaining desired functionality. For example, neckband 705 may allow components that would otherwise be included on an eyewear device to be included in neckband 705 since users may tolerate a heavier weight load on their shoulders than they would tolerate on their heads. Neckband 705 may also have a larger surface area over which to diffuse and disperse heat to the ambient environment. Thus, neckband 705 may allow for greater battery and computation capacity than might otherwise have been possible on a stand-alone eyewear device. Since weight carried in neckband 705 may be less invasive to a user than weight carried in eyewear device 702, a user may tolerate wearing a lighter eyewear device and carrying or wearing the paired device for greater lengths of time than a user would tolerate wearing a heavy standalone eyewear device, thereby enabling users to more fully incorporate artificial-reality environments into their day-to-day activities.

Neckband 705 may be communicatively coupled with eyewear device 702 and/or to other devices. These other devices may provide certain functions (e.g., tracking, localizing, depth mapping, processing, storage, etc.) to augmented-reality system 700. In the embodiment of FIG. 7, neckband 705 may include two acoustic transducers (e.g., 720(1) and 720(J)) that are part of the microphone array (or potentially form their own microphone subarray). Neckband 705 may also include a controller 725 and a power source 735.

Acoustic transducers 720(1) and 720(J) of neckband 705 may be configured to detect sound and convert the detected sound into an electronic format (analog or digital). In the embodiment of FIG. 7, acoustic transducers 720(1) and 720(J) may be positioned on neckband 705, thereby increasing the distance between the neckband acoustic transducers 720(1) and 720(J) and other acoustic transducers 720 positioned on eyewear device 702. In some cases, increasing the distance between acoustic transducers 720 of the microphone array may improve the accuracy of beamforming performed via the microphone array. For example, if a sound is detected by acoustic transducers 720(C) and 720(D) and the distance between acoustic transducers 720(C) and 720(D) is greater than, e.g., the distance between acoustic transducers 720(D) and 720(E), the determined source location of the detected sound may be more accurate than if the sound had been detected by acoustic transducers 720(D) and 720(E).

Controller 725 of neckband 705 may process information generated by the sensors on neckband 705 and/or augmented-reality system 700. For example, controller 725 may process information from the microphone array that describes sounds detected by the microphone array. For each detected sound, controller 725 may perform a direction-of-arrival (DOA) estimation to estimate a direction from which the detected sound arrived at the microphone array. As the microphone array detects sounds, controller 725 may populate an audio data set with the information. In embodiments in which augmented-reality system 700 includes an inertial measurement unit, controller 725 may compute all inertial and spatial calculations from the IMU located on eyewear device 702. A connector may convey information between augmented-reality system 700 and neckband 705 and between augmented-reality system 700 and controller 725. The information may be in the form of optical data, electrical data, wireless data, or any other transmittable data form. Moving the processing of information generated by augmented-reality system 700 to neckband 705 may reduce weight and heat in eyewear device 702, making it more comfortable to the user.

Power source 735 in neckband 705 may provide power to eyewear device 702 and/or to neckband 705. Power source 735 may include, without limitation, lithium-ion batteries, lithium-polymer batteries, primary lithium batteries, alkaline batteries, or any other form of power storage. In some cases, power source 735 may be a wired power source. Including power source 735 on neckband 705 instead of on eyewear device 702 may help better distribute the weight and heat generated by power source 735.

As noted, some artificial-reality systems may, instead of blending an artificial reality with actual reality, substantially replace one or more of a user's sensory perceptions of the real world with a virtual experience. One example of this type of system is a head-worn display system, such as virtual-reality system 800 in FIG. 8, that mostly or completely covers a user's field of view. Virtual-reality system 800 may include a front rigid body 802 and a band 804 shaped to fit around a user's head. Virtual-reality system 800 may also include output audio transducers 806(A) and 806(B). Furthermore, while not shown in FIG. 8, front rigid body 802 may include one or more electronic elements, including one or more electronic displays, one or more inertial measurement units (IMUS), one or more tracking emitters or detectors, and/or any other suitable device or system for creating an artificial-reality experience.

Artificial-reality systems may include a variety of types of visual feedback mechanisms. For example, display devices in augmented-reality system 700 and/or virtual-reality system 800 may include one or more liquid crystal displays (LCDs), light emitting diode (LED) displays, microLED displays, organic LED (OLED) displays, digital light project (DLP) micro-displays, liquid crystal on silicon (LCoS) micro-displays, and/or any other suitable type of display screen. These artificial-reality systems may include a single display screen for both eyes or may provide a display screen for each eye, which may allow for additional flexibility for varifocal adjustments or for correcting a user's refractive error. Some of these artificial-reality systems may also include optical subsystems having one or more lenses (e.g., concave or convex lenses, Fresnel lenses, adjustable liquid lenses, etc.) through which a user may view a display screen. These optical subsystems may serve a variety of purposes, including to collimate (e.g., make an object appear at a greater distance than its physical distance), to magnify (e.g., make an object appear larger than its actual size), and/or to relay (to, e.g., the viewer's eyes) light. These optical subsystems may be used in a non-pupil-forming architecture (such as a single lens configuration that directly collimates light but results in so-called pincushion distortion) and/or a pupil-forming architecture (such as a multi-lens configuration that produces so-called barrel distortion to nullify pincushion distortion).

In addition to or instead of using display screens, some of the artificial-reality systems described herein may include one or more projection systems. For example, display devices in augmented-reality system 700 and/or virtual-reality system 800 may include micro-LED projectors that project light (using, e.g., a waveguide) into display devices, such as clear combiner lenses that allow ambient light to pass through. The display devices may refract the projected light toward a user's pupil and may enable a user to simultaneously view both artificial-reality content and the real world. The display devices may accomplish this using any of a variety of different optical components, including waveguide components (e.g., holographic, planar, diffractive, polarized, and/or reflective waveguide elements), light-manipulation surfaces and elements (such as diffractive, reflective, and refractive elements and gratings), coupling elements, etc. Artificial-reality systems may also be configured with any other suitable type or form of image projection system, such as retinal projectors used in virtual retina displays.

The artificial-reality systems described herein may also include various types of computer vision components and subsystems. For example, augmented-reality system 700 and/or virtual-reality system 800 may include one or more optical sensors, such as two-dimensional (2D) or 3D cameras, structured light transmitters and detectors, time-of-flight depth sensors, single-beam or sweeping laser rangefinders, 3D LiDAR sensors, and/or any other suitable type or form of optical sensor. An artificial-reality system may process data from one or more of these sensors to identify a location of a user, to map the real world, to provide a user with context about real-world surroundings, and/or to perform a variety of other functions.

The artificial-reality systems described herein may also include one or more input and/or output audio transducers. Output audio transducers may include voice coil speakers, ribbon speakers, electrostatic speakers, piezoelectric speakers, bone conduction transducers, cartilage conduction transducers, tragus-vibration transducers, and/or any other suitable type or form of audio transducer. Similarly, input audio transducers may include condenser microphones, dynamic microphones, ribbon microphones, and/or any other type or form of input transducer. In some embodiments, a single transducer may be used for both audio input and audio output.

In some embodiments, the artificial-reality systems described herein may also include tactile (i.e., haptic) feedback systems, which may be incorporated into headwear, gloves, body suits, handheld controllers, environmental devices (e.g., chairs, floormats, etc.), and/or any other type of device or system. Haptic feedback systems may provide various types of cutaneous feedback, including vibration, force, traction, texture, and/or temperature. Haptic feedback systems may also provide various types of kinesthetic feedback, such as motion and compliance. Haptic feedback may be implemented using motors, piezoelectric actuators, fluidic systems, and/or a variety of other types of feedback mechanisms. Haptic feedback systems may be implemented independent of other artificial-reality devices, within other artificial-reality devices, and/or in conjunction with other artificial-reality devices.

By providing haptic sensations, audible content, and/or visual content, artificial-reality systems may create an entire virtual experience or enhance a user's real-world experience in a variety of contexts and environments. For instance, artificial-reality systems may assist or extend a user's perception, memory, or cognition within a particular environment. Some systems may enhance a user's interactions with other people in the real world or may enable more immersive interactions with other people in a virtual world. Artificial-reality systems may also be used for educational purposes (e.g., for teaching or training in schools, hospitals, government organizations, military organizations, business enterprises, etc.), entertainment purposes (e.g., for playing video games, listening to music, watching video content, etc.), and/or for accessibility purposes (e.g., as hearing aids, visual aids, etc.). The embodiments disclosed herein may enable or enhance a user's artificial-reality experience in one or more of these contexts and environments and/or in other contexts and environments.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A device comprising:
a substrate; and
an array of beam splitters embedded within the substrate, wherein each beam splitter within the array of beam splitters does not fully transect the substrate.

2. The device of claim 1, wherein each beam splitter within the array of beam splitters is configured to transmit a first proportion of rays and to reflect a second proportion of rays toward an output of the device.

3. The device of claim 1, wherein:
the device is configured to provide a plurality of ray paths from an input of the device to an output of the device; and
at least one ray path within the plurality of ray paths bypasses at least one beam splitter and intersects with at least one subsequent beam splitter.

4. The device of claim 1, wherein each beam splitter within the array of beam splitters is progressively more reflective in a direction of an output of the device.

5. The device of claim 4, wherein an average amount of light reflected out of the device by each beam splitter within the array of beam splitters is substantially uniform.

6. The device of claim 5, wherein the average amount of light reflected out of the device by each beam splitter within the array of beam splitters is substantially uniform based on at least:
a proportion of ray paths that bypass each beam splitter within the array of beam splitters; and
a degree of reflectivity of each beam splitter within the array of beam splitters.

7. The device of claim 1, wherein each beam splitter within the array of beam splitters is progressively longer in a direction of an output of the device.

8. The device of claim 1, wherein a first beam splitter within the array of beam splitters is set at a different angle within the device than a second beam splitter within the array of beam splitters.

9. A method of manufacture comprising:
removing material from a substrate such that the substrate defines a series of sloping grooves;
applying a partially reflective coating over a slope of each of the sloping grooves; and
overcasting the substrate with additional material such that the series of sloping grooves are filled in and the partially reflective coating is fully surrounded by substrate.

10. The method of manufacture of claim 9, wherein the substrate comprises a polymer material.

11. The method of manufacture of claim 9, wherein applying the partially reflective coating comprises applying a gradient of progressively more reflecting coating such that partially reflective coating of each groove in the series of sloping grooves is progressively more reflective.

12. The method of manufacture of claim 9, further comprising, after applying the partially reflective coating and before overcasting the substrate, removing the partially reflective coating from one or more portions of a surface of the substrate.

13. The method of manufacture of claim 9, wherein removing the material from the substrate such that the substrate defines the series of sloping grooves comprises removing material to different depths at different positions of the substrate such that a maximum depth of at least one sloping groove within the series of sloping grooves differs from a maximum depth of at least one other sloping groove within the series of sloping grooves.

14. A system comprising:
a head-mounted display comprising a waveguide, the waveguide comprising:
a substrate; and
an array of beam splitters embedded within the substrate, wherein each beam splitter within the array of beam splitters does not fully transect the substrate.

15. The system of claim 14, wherein each beam splitter within the array of beam splitters is configured to transmit a first proportion of rays and to reflect a second proportion of rays toward an output of the waveguide.

16. The system of claim 14, wherein:
the waveguide is configured to provide a plurality of ray paths from an input of the waveguide to an output of the waveguide; and
at least one ray path within the plurality of ray paths bypasses at least one beam splitter and intersects with at least one subsequent beam splitter.

17. The system of claim 14, wherein each beam splitter within the array of beam splitters is progressively more reflective in a direction of an output of the waveguide.

18. The system of claim 17, wherein an average amount of light reflected out of the waveguide by each beam splitter within the array of beam splitters is substantially uniform.

19. The waveguide of claim 18, wherein the average amount of light reflected out of the waveguide by each beam splitter within the array of beam splitters is substantially uniform based on:
a proportion of ray paths that bypass each beam splitter within the array of beam splitters; and
a reflectivity of each beam splitter within the array of beam splitters.

20. The system of claim 14, wherein each beam splitter within the array of beam splitters is progressively longer in a direction of an output of the waveguide.
